(19) United States
(12) Patent Application Publication
(10) Pub. No.: US 2006/0068156 A1
(43) Pub. Date: Mar. 30, 2006

(54) Pile weatherstrip and the manufacture thereof

(75) Inventors: Charles Holiday, Crook (GB); Joseph Coles, Woodham Village (GB)

Correspondence Address: GOODWIN PROCTER LLP;PATENT ADMINISTRATOR, EXCHANGE PLACE, BOSTON, MA, 02109-2881, US

(73) Assignee: Linear Limited, Newton Aycliffe (GB)

(21) Appl. No.: 11/233,517

(22) Filed: Sep. 22, 2005

(30) Foreign Application Priority Data
Sep. 29, 2004 (GB) 0421628.9

(51) Int. Cl. E06B 7/16; B32B 33/00

(52) U.S. Cl. 428/93; 428/92; 428/95; 49/475.1

(57) ABSTRACT

A pile weatherstrip is formed from a multiple-filament yarn that is knitted into a tape where the yarn lengths extend side-by-side in a direction normal to the length of the tape. Side-by-side yarns are held together by stitching to form a coherent tape which is then fed to a connection zone where the tape is formed into a V and the base of the V is welded into a channel on a carrier. After welding, the top ends of the V-shaped tape are cut off to form a pile.

### CROSS-REFERENCE TO RELATED APPLICATIONS

This application claims priority to and incorporates by reference in its entirety U.K. Application 0421628.9 filed Sep. 29, 2004.

### FIELD OF THE INVENTION

The invention relates to pile weatherstrip and to the manufacture of pile weatherstrip. Pile weatherstrip is formed by a carrier and a dense pile of fibres extending from the carrier. Pile weatherstrip is generally used in doors or windows where it is mounted between an opening leaf and a fixed frame to provide draft exclusion and/or anti-rattle capabilities.

### BACKGROUND

A known way of forming such pile weatherstrip is to provide a woven base onto which is a formed plurality of rows of pile by, for example, a weaving process. The base is then coated with a plastics material to form the carrier before being cut between the rows to form individual strips.

This process is subject to significant waste since the cutting between the rows of pile is not always accurate. In addition, it is not easy in such a method to alter either the density of the pile or the height of the pile; this requires significant alteration of the machinery used to form the pile.

U.S. Pat. No. 4,148,953 shows an alternative method in which yarn is wound over a membrane strip and the edges of the strip are then inserted into respective carriers where the edges are welded to the carriers. The strip and the carrier are then slit longitudinally to form two pile weatherstrips.

### SUMMARY OF THE INVENTION

According to a first aspect of the invention, there is provided a method of forming a pile weatherstrip comprising forming a multi-filament yarn into a tape in which the filaments extend generally transverse to the length of the tape, the tape having spaced side edges, connecting the tape to an elongate carrier along a line extending along the tape intermediate said side edges, the tape being cut along two cut-lines, each line being generally parallel to the connection line and each line being spaced inwardly of an associated side edge to form a pile.

The tape can be made with any required filament density and filament length and the height of the pile can be chosen by adjusting the location of the cut-lines. Thus, pile weatherstrip can be produced very cheaply and easily in a variety of sizes and pile densities.

According to a second aspect of the invention, there is provided a pile weatherstrip comprising a carrier, a knitted tape formed from a multi-filament yarn in which the filaments extend generally transverse to the tape, the tape being connected to the carrier along a centre line of the tape.

According to a third aspect of the invention, there is provided a machine for forming a pile weatherstrip comprising first feed means for feeding a carrier to a connection zone, second feed means for feeding to the connection zone a tape formed of multi-filament yarn in which the filaments extend generally transverse to the length of the tape, the second feeding means folding the tape into a V-section configuration, and connecting means in the connection zone for connecting the base of the V-section to the carrier.

The following is a more detailed description of an embodiment of the invention, by way of example, reference being made to the accompanying drawings in which:—

### DESCRIPTION OF THE DRAWINGS

FIG. 1 is a plan view from above of a part of a knitted tape for incorporation into a pile weatherstrip;

FIG. 2 is a schematic view of the machine for forming a pile weatherstrip from the tape of FIG. 1; and

FIG. 3 is a schematic cross-section of a completed pile weatherstrip formed using the machine of FIG. 2.

### DESCRIPTION OF THE PREFERRED EMBODIMENTS

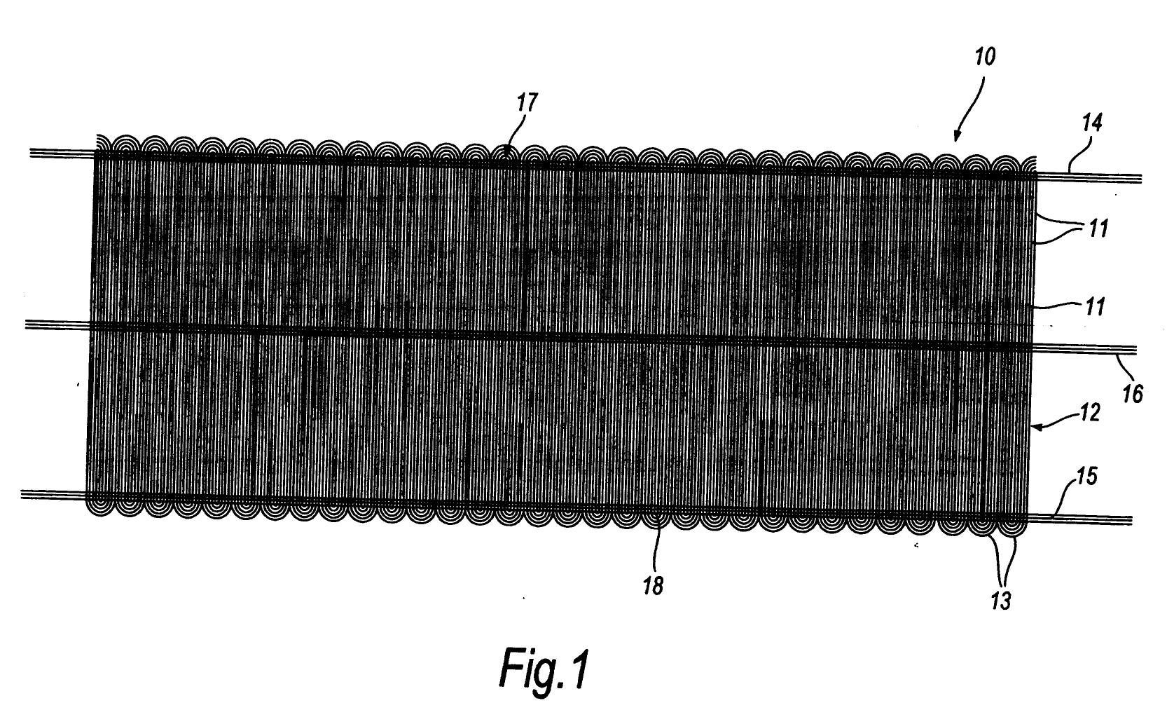

Referring first to FIG. 1, the tape 10 is formed from a plurality of multi-filament yarns 11 which may, for example, be made of polypropylene. The yarns are formed into the tape 10 by a knitting process in which each yarn 11 is looped in a serpentine path with parallel straight portions 12 interconnected by curved portions 13. In this way, the filaments of the yarns 11 extend generally side-by-side in a direction transverse to the length of the tape.

The knitted yarns 11 are held together by first, second and third lines of stitching 14, 15, 16. The first and second lines of stitching 14, 15 are located adjacent respective opposite side edges 17, 18 of the tape 10. The third line of stitching 16 extends along the centre line of the tape 10.

In this way, a tape 10 is formed that is coherent and can be readily handled without damage. The tape 10 can have any required width adjusted by adjustment of the knitting machine. The density of the yarns 11, the materials of the yarns 11 and the number of yarns making up the tape 10 can all be chosen as required.

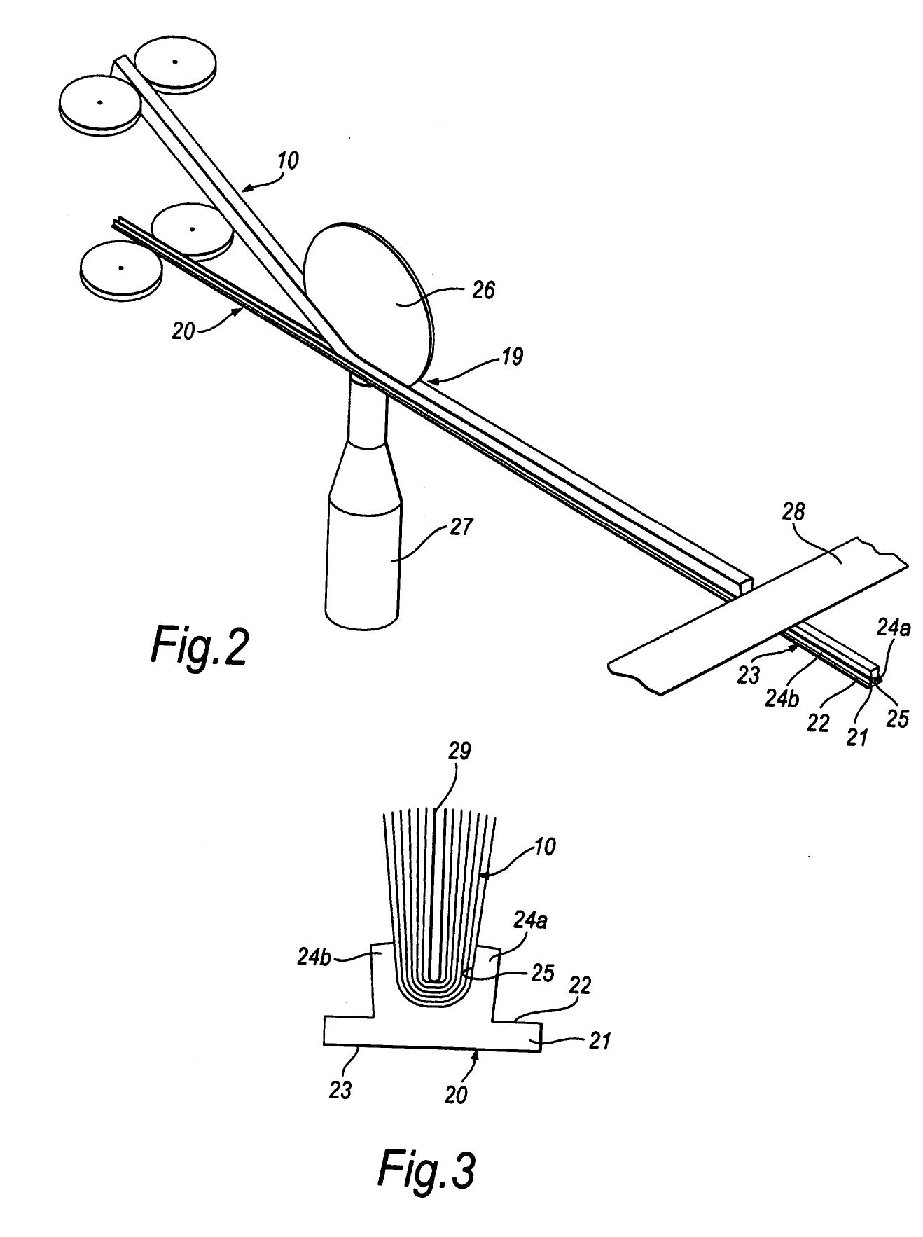

The tape 10 is used in a machine shown schematically in FIG. 2. In the machine, the tape 10 is fed to a connection zone, indicated generally at 19, by first feed means. These feed means configure the tape 10 into a V-shaped cross-section with the third row of stitching 16 at the base of the V.

Second feed means feed a carrier 20 to the connection zone 19. The carrier 20 is formed from a solid plastics material and comprises a base 21 having an upper surface 22 and a lower surface 23. The upper surface 22 is formed with a pair of longitudinally extending side-by-side spaced ribs 24a, 24b so that the ribs 24a, 24b and the upper surface form a channel 25.

At the connection zone 19, the base of the V-section tape 10 is inserted into the channel in a nip formed between a roller 26 and a ultrasonic welding head 27. At this point, the tape 10 and the carrier 20 are heated to weld the tape 10 to the carrier 20 along the third stitching line 16.

If required, an air permeable fin 29 (see FIG. 3) can also be introduced into the V of the tape 10 at the connection zone 19 and welded to the tape 10 at the same time as the tape 10 is welded to the carrier 20.

A cutter 28 is located downstream of the connection zone 19 in the direction of travel of the tape 10. The cutter 28 cuts the yarns 11 forming the tape 10 along two cut-lines. Each cut-line is generally parallel to the length of the tape and extends inwardly of an associated side edge 17, 18 of the tape 10 and inwardly of the associated stitching 14, 15. Thus, this cut removes the first and second stitching 14, 15 and forms the yarns 11 into a pile.

In this way, the transverse lengths of the yarns 11 are provided with free ends and so form a pile on the carrier. In this way, a pile weatherstrip is formed. It will be appreciated that the height of the cutter 28 can be adjusted as required to alter the pile height.

The pile weatherstrip is easily and quickly formed in a single welding step. No slitting of the carrier is required and the pile weatherstrip is immediately available for use. The amount of waste is reduced.

It will be appreciated that there are a number of changes that can be made to the pile weatherstrip and the method and the machine described above. The connection between the tape 10 and the carrier 20 need not be formed by using ultrasonic welding; it could be by use of a laser. The dimensions of the carrier 20 can be altered as required.

The tape 10 is described above as being formed by knitting. It could be formed in any other convenient way such as by crocheting. The side-by-side lengths of yarns 11 are shown connected by stitching. More or less rows of stitching could be used and/or the stitching could be replaced by, for example, welding or any other convenient connection method.

The height of the pile on the carrier 20 could be changed in a step-wise fashion during a single production run to produce in a single production run, pile weatherstrip having two different pile heights.

Although the embodiment described above with reference to the drawings has the tape 10 cut after the tape 10 has been welded to the corner 20, this is not essential. The edges of the tape 10 could be cut prior to welding. This allows the possibility of having pile of differing heights to either side of the weld and to either side of a fin where such is provided.

We claim:

1. A method of forming a pile weatherstrip comprising forming a multi-filament yarn into a tape in which the filaments extend generally transverse to the length of the tape, the tape having spaced side edges, connecting the tape to an elongate carrier along a line extending along the tape intermediate said side edges, and cutting the tape along two cut lines, each line being generally parallel to the connection line and each line being spaced inwardly of an associated side edge to form a pile.

2. A method according to claim 1 wherein the tape is cut along said lines after the tape is connected to the carrier.

3. A method according to claim 1 wherein the tape is cut along said lines before the tape is connected to the carrier.

4. A method according to claim 1 wherein the tape is formed from at least one multi-filament yard looped into a plurality of side-by-side lengths interconnected by curved portions.

5. A method to claim 4 wherein the tape is formed by knitting.

6. A method according to claim 4 wherein the tape is formed by crocheting.

7. A method according to claim 4 wherein the tape is formed of a plurality of multi-filament yarns.

8. A method according to claim 1 and comprising interconnecting said side-by-side yarn lengths along two connecting lines, each line being generally parallel to the length of the tape and each line being adjacent a respective side edge, each cut line being spaced inwardly of the associated connection line.

9. A method according to claim 8 wherein the connection lines are formed by stitching.

10. A method according to claim 1 and comprising interconnecting said side-by-side yarn lengths along the centre line of the tape, said connection line extending along said interconnection line.

11. A method according to claim 10 wherein said interconnection is by stitching.

12. A method according to claim 1 wherein the connection step comprises folding the tape into a V-shape along a centre line of the tape and then connecting the tape to the carrier along said line to form said connection.

13. A method according to claim 12 wherein the yarn and the carrier are formed from respective thermoplastic materials, the connection being formed by a welding process.

14. A method according to claim 13 wherein the welding process is an ultrasonic welding process.

15. A method according to claim 13 wherein the welding process is a laser welding process.

16. A method according to claim 1 wherein the carrier is formed by a base having a surface, the surface including two side-by-side but spaced ribs defining a channel with said base surface, the connection between the carrier and the tape extending along said channel.

17. A method according to claim 1 and including the further step of incorporating an air-impervious fin into the weatherstrip.

18. A method according to claim 17 wherein the fin is connected to the tape along said connection line.

19. A method according to claim 18 wherein the yarn and the carrier are formed from respective thermoplastic materials, the connection being formed by a welding process and wherein the fin is formed of a thermoplastic material, the fin being welded to the tape as the tape is welded to the carrier.

20. A pile weatherstrip comprising a carrier, a knitted tape formed from a multi-filament yarn in which the filaments extend generally transverse to the tape, the tape being connected to the carrier along a centreline of the tape and forming a pile.

21. A weatherstrip according to claim 20 wherein the tape has spaced side edges, the tape being cut along lines extending generally parallel to the length of the tape to form said pile, each line being inwards of an associated side edge of the tape.

22. A weatherstrip according to claim 20 wherein the tape includes a line of stitching extending along a centreline of the tape to inter-connect said filament yarn, the connection between the tape and the carrier extending along said centreline.

23. A machine for forming a pile weatherstrip comprising a first feed means for feeding a carrier to a connection zone, second feed means for feeding to the connection zone a tape formed of multi-filament yard in which the filaments extend generally transverse to the length of the tape, the second feed means folding the tape into a V-section configuration, and connecting means in the connection zone for connecting the base of the V-section to the carrier.

24. A machine according to claim 23 and including cutting means after the connection zone for cutting the tape along two lines, each line being spaced inwardly of an associated side edge of the tape to form a pile.

25. A machine according to claim 23 wherein the connecting means comprise an ultrasonic welding device.

26. A machine according to claim 23 wherein the connecting means comprise a laser.
